(19) United States
(12) Patent Application Publication
(10) Pub. No.: US 2007/0041095 A1
(43) Pub. Date: Feb. 22, 2007

(54) DISPLAY DEVICE, METHOD OF CONTROLLING THE SAME, AND GAME MACHINE

(75) Inventors: Eiji NAKAYA, Suwa-shi, Nagano-ken (JP); Masakazu ZAKOJI, Suwa-shi, Nagano-ken (JP); Shuichi WAKABAYASHI, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/465,324

(22) Filed: Aug. 17, 2006

(30) Foreign Application Priority Data
Aug. 22, 2005 (JP) 2005-239402

(51) Int. Cl. G02B 27/22

(52) U.S. Cl. 359/463

(57) ABSTRACT

A display device includes a display panel having a planar image display area, a barrier device having a barrier disposed opposing to the image display area, and switchable between an operative state for allowing stereoscopic viewing and an inoperative state for disabling stereoscopic viewing, wherein in the operative state, the barrier device can locally be set to a partial operative state in which a part of the image display area is covered by the barrier, and a control device that outputs barrier control information to the barrier device to make the barrier device switch the state of the barrier including the partial operative state.

### BACKGROUND

1. Technical Field

The present invention relates to a display device or the like to be preferably implemented in a game machine such as a pinball machine, a slot machine, or a arcade game, and particularly to a display device for performing display, which an observer can view stereoscopically, a control method therefor, and a game machine implementing the display device.

2. Related Art

As a display device for offering a stereoscopic vision, there is a device in which each of images or equivalent images thereto obtained by taking pictures of an object in three dimensions using four cameras into sub-pixels is divided, the sub-pixels are repeatedly displayed on a flat panel display in accordance with the positions of the four cameras, and the flat panel display is observed through a step barrier (2004, SPIE-IS&T/Vol. 5291 (p 265-272), “Step barrier system multi-view glass-less 3-D display,” hereinafter referred to as first document).

Incidentally, as a game machine, there is a machine, which variably displays numbers or the like on a display disposed on a center section of a pachinko board in response to a pachinko ball entering a start-up hole to win a prize, and pays out corresponding prize balls when the same numbers or the like stop in a line as a bell ringer. As a display device for a game machine of this kind, for example, there is a display device having a pair of light sources, a pair of polarizing filters corresponding respectively to the pair of light sources, a Fresnel lens, a fine wave plate, a first polarization plate, a liquid crystal panel, and a second polarization plate sequentially disposed along the light path (JP-A-2005-52200, hereinafter referred to as second document). In this display device, an image for a right eye and an image for a left eye are formed in combination on the liquid crystal display panel in accordance with the pattern of the fine wave plate, the pop-up amount of the image is set by the difference in the pixel positions between the image for a right eye and the image for a lift eye.

Further, as another game machine, there is a machine, which implements a stereoscopic display device provided with an image splitter having transparent sections and opaque sections alternately to allow the player to view the game pictures stereoscopically using the binocular parallax method (JP-A-9-164263, hereinafter referred to as third document). In this stereoscopic display device, there are provided a left eye image signal switching circuit and a right eye image signal switching circuit to switch between a plane image and a stereoscopic image in accordance with an instruction form a display CPU.

However, regarding the display device (in the first document) for a stereoscopic vision mentioned above, there is an only disclosure that it can display a stereoscopic vision, but there is no other disclosure about a switching display between a stereoscopic image and a plane image, nor a stereoscopic display according to the proceeding of a game.

Further, although the game machines (in the second and third documents) with the stereoscopic display can display a stereoscopic image and a plane image by switching therebetween, if it is modified to be able to display various stereoscopic images, the load of the image processing system for realizing the stereoscopic vision becomes large in particular in displaying moving images. Namely, if the three-dimensional drawing process is performed in real time, a high performance image processing circuit is required, thus increasing the cost and restricting implementation in the game machine usage in view of a heat generation problem. Further, in the case in which the moving image is displayed by frame-by-frame advance using the result of the three-dimensional drawing process performed previously in the out side and stored in an image storing memory, if a high image quality needs to be assured, in view of the restrictions in the image compression method, a need for providing unfeasible amount of image storing memory arises, as a result.

### SUMMARY

Therefore, in view of the above, the invention has an advantage of providing a display device, which is low in price and can easily applied to the usage of the game machine or the like, a control method therefor, and a game machine implementing the display device.

A display device according to an aspect of the invention includes (a) a display panel having a planar image display area, (b) a barrier device having a barrier disposed opposing to the image display area, and switchable between an operative state for allowing stereoscopic viewing and an inoperative state for disabling stereoscopic viewing, wherein in the operative state, the barrier device can locally be set to a partial operative state in which a part of the image display area is covered by the barrier, and (c) a control device that outputs barrier control information to the barrier device to make the barrier device switch the state of the barrier including the partial operative state.

In the display device described above, since the barrier device is switchable between the operative state for allowing stereoscopic viewing and the inoperative state for disabling stereoscopic viewing, it becomes possible to perform display with enhanced seasoning by the stereoscopic viewing with necessary timing such as in the stage requiring warming up of the performance in view of the proceeding of the game. Further, since in the present display device, the barrier device can locally be set to a partial operative state in which a part of the image display area is covered by the barrier, the partial stereoscopic viewing becomes possible only by displaying the stereoscopic viewing image in the selective area covered by the barrier, thus the process of stereoscopic viewing, which requires relatively large amount of computation and relatively large amount of memory, can be limited to the selected area. Therefore, the load to the mage processing when displaying the stereoscopic viewing image can be reduced, thus an inexpensive display device suitable for implementation to the game machines can be provided.

According to the specific aspect or viewpoint of the invention, in the display device described above, the barrier device is divided into a plurality of partial areas, and in the partial operative state, each of the partial areas is set to either one of the operative state or the inoperative state. In this case, either of the operative state or the inoperative state is set for every partial area, thus various forms of stereoscopic viewing display can be realized by appropriately changing the display areas according to needs.

According to another aspect of the invention, the barrier device includes a drive circuit that switches each of the partial areas to one of the operative state and the inoperative state. In this case, by transmitting a predetermined control signal to the drive circuit belonging to the barrier device, each of the partial areas can be set either one of the operative state and the inoperative state.

According to still another aspect of the invention, the display panel operates in accordance with image data input to the display panel, and the control device includes the barrier control information in the image data, and the barrier device includes a barrier control device that separates the barrier control information from the image data. In this case, since the barrier control information can be included in the image data, and the barrier control information can be separated from the image data by the barrier device side, conventional data communication lines without accompanying the barrier control can be used, thus the partial stereoscopic viewing can be realized with relatively simple modification of the conventional circuit system.

According to still another aspect of the invention, the control device performs additional blending of a predetermined digit of a digital brightness signal forming the image data with a predetermined signal including the barrier control information in this case, the barrier control information can be overlapped with the image data, thus the output specification (e.g., number of bits or signal elements) of the image data can be used for the barrier control without changing the specification. It should be noted that if the image data and the predetermined signals are additionally blended, the image data is modified. However, by setting the condition not to degrade the stereoscopic viewing, no substantial problems are caused.

According to still another aspect of the invention, the control device replaces at least a part of a left vertical line of a digital brightness signal forming the image data with the barrier control information. In this case, the barrier control information can easily be overlapped with the image data, thus the output specification of the image data can be used for the barrier control without changing the specification.

According to still another aspect of the invention, the control device replaces at least a part of a left vertical line of a digital brightness signal relating to a predetermined color forming the image data with the barrier control information. In this case, the barrier control information can easily be overlapped with the image data, thus the output specification of the image data can be used for the barrier control without changing the specification. It should be noted that by selecting the predetermined color as visually indistinctive one, the modification of the stereoscopic viewing image becomes less sensible.

According to still another aspect of the invention, a communication cable for transmitting the barrier control information output from the control device to the barrier device. In this case, the state of the every partial area can be switched with a simple signal output without adding any modifications to the image data.

Further, a game machine according to another aspect of the invention includes (a) the display device according to above aspect of the invention that performs stereoscopic viewing in a display section, (b) a performance control device that makes the display device perform stereoscopic viewing display in accordance with status of the game.

According to the game machine, the display device is implemented therein, and since the game machine makes the display device perform the stereoscopic viewing display in accordance with the proceeding of the game, the game with enhanced seasoning becomes possible. In this case, in the display device, partial stereoscopic viewing becomes possible only by displaying the stereoscopic viewing image only in the selected area covered by the barrier, and the processing of the stereoscopic viewing image can be limited in the selected area. Therefore, the load of image processing in displaying the stereoscopic viewing image can be reduced, thus various forms of display become possible in the game machine having special restrictions.

Further, a method of controlling a display device according to another aspect of the invention is a method of controlling a display device switchable between an operative state for allowing stereoscopic viewing and inoperative state for disabling stereoscopic viewing including setting locally, in the operative state, the barrier device to a partial operative state in which a part of the image display area is covered by the barrier.

In the control method described above, partial stereoscopic viewing becomes possible only by displaying the stereoscopic viewing image only in the selected area covered by the barrier, and the processing of the stereoscopic viewing image can be limited in the selected area. Therefore, the load of image processing in displaying the stereoscopic viewing image can be reduced, thus an inexpensive display device suitable for implementation to the game machines can be provided.

Further, another control method of a display device controls the display device described above, thus the partial stereoscopic viewing of the display device becomes possible.

Further, a control method of a game machine according to another aspect of the invention controls the game machine described above, thus the partial stereoscopic viewing of the display device becomes possible.

### BRIEF DESCRIPTION OF THE DRAWINGS

The invention will now be described with reference to the accompanying drawings, wherein like numbers refer to like elements.

FIG. 1 is a front view showing the whole of a game machine according to an embodiment of the invention.

FIG. 2 is a block diagram of a control system of the game machine shown in FIG. 1.

FIG. 3 is a cross-sectional view for explaining the structure of an image display device.

FIGS. 4A through 4E are enlarged views for explaining an example of an arrangement of display pixels in a liquid crystal display section.

FIG. 5 is a front view showing a specific example of stereoscopic display by the image display device.

FIG. 6 is a front view for explaining the structure and a role of an LCD barrier provided to the image display device.

FIG. 7 is a diagram for explaining roles of an output interface and so on provided to a display control device.

FIGS. 8A through 8E are charts each showing an output wave form of respective one of output interface terminals.

FIGS. 9A through 9C are diagrams for explaining image data output from the output interface.

FIG. 10 is a diagram for explaining a modified example of the output interfaces and so on shown in FIG. 7.

FIGS. 11A through 11C are diagrams for explaining image data output from the output interface.

FIG. 12 is a block diagram for explaining a display control device according to a second embodiment.

FIG. 13 is a block diagram for explaining a display control device according to a third embodiment.

FIG. 14 is a block diagram for explaining a display control device according to a fourth embodiment.

### DESCRIPTION OF EXEMPLARY EMBODIMENTS

### First Embodiment

Hereinafter, a game machine and a display device implemented thereto according to a first embodiment of the invention will be explained with reference to the accompanying drawings.

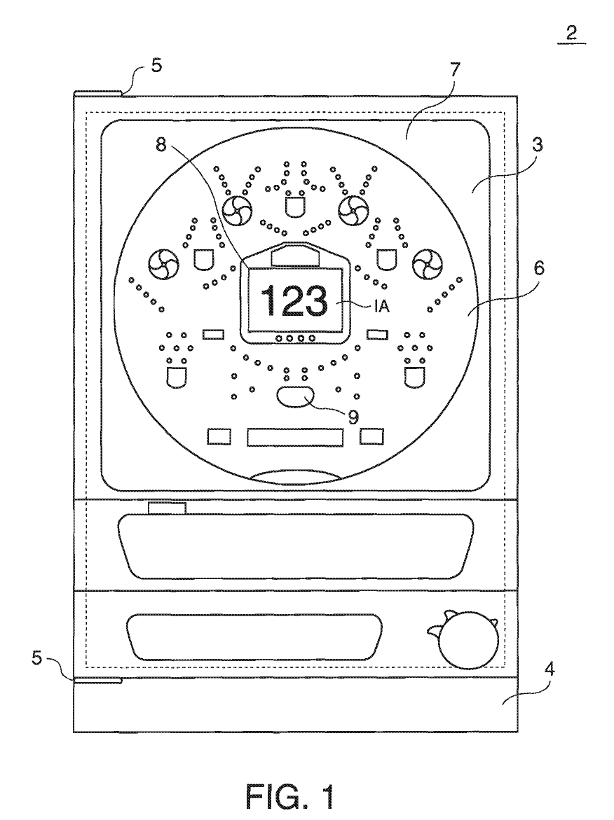

FIG. 1 is a front view of the game machine according to the present embodiment. The game machine 2 is a pachinko machine, and is provided with a front face frame 3, a main body frame 4, and a game board 6. The front face frame 3 is rotatably attached to the main body frame 4 outside thereof via a hinge 5 so as to be opened and closed, and the game board 6 is housed in a housing frame attached to the back side of the front face frame 3. The front face frame 3 is provided with a cover glass 7 attached thereto for covering the front face of the game board 6.

On the surface of the game board 6, there is formed a game area surrounded by a guide rail, and in substantially the center of the game area, there is provided an image display device 8 as a device for displaying a special design. The image display device 8 can display an image, which can be viewed stereoscopically using the parallax effect in the left and right eyes by shifting the left-eye image and the right-eye image from each other to display them in the positions different from each other.

The image display device 8 includes a display screen formed of an LCD (liquid crystal display), namely an image display area IA. In the image display area IA, there can be provided a plurality of varying display areas, for example, each displaying images including identification information (the special design, a standard design), characters acting a game with varying display and so on. Namely, in the varying display areas respectively disposed on the left, center, and right in the center portion of the image display area IA, designs (e.g., fourteen kinds of designs composed of numbers of zero through nine and alphabetical characters off A through D) assigned as the identification information are displayed as varying images, thus the game with varying display is performed. Besides the above, in the image display area IA, in accordance with the proceeding, images corresponding to the present proceeding are displayed.

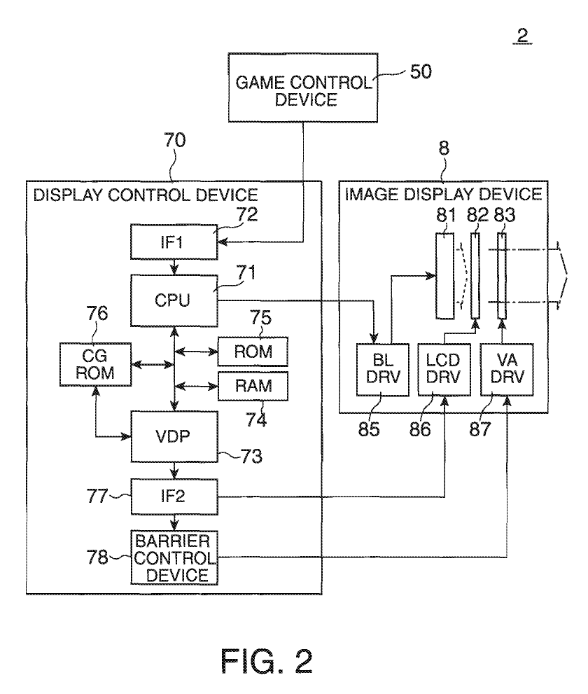

FIG. 2 is a block diagram showing the structure of the image display device 8 and a control system relating thereto in the game machine 2 shown in FIG. 1.

A game control device 50 is a main control device for integrally controlling the game. The game control device 50 corresponds to performance control means according to the invention, and is a central section for controlling the proceeding of the game such as detection of the prizewinning ball, paying out of the prize balls, and the game with the varying display. However, the device can be configured with typical device configuration, and accordingly the explanation of the specific configuration thereof will be omitted here.

A display control device 70 is a section for appropriately operating the image display device 8 by processing and operating the image control information (e.g., design display information, background screen information, the three-dimensional display image, and so on) for the game with the varying display in accordance with instructions from the game control device 50. The display control device 70 is provided with a CPU 71, an input interface 72, a video processor 73, a work RAM 74, a program ROM 75, a CGROM 76, an output interface 77, and a barrier control section 78 as shown in the drawing. The display control device 70 is basically configured as a processing circuit for a two-dimensional image, but is capable of performing various display control of, for example, displaying or moving two-dimensional images (i.e., plane images) such as a character or a lottery design, or three-dimensional images (i.e., stereoscopic images) on the background image.

It should be noted here that, the CPU 71 and the video processor 73 treat image data for stereoscopic viewing as, for example, a group of two-dimensional display data and function as control means for controlling the operational state of the image display device 8, and the video processor 73, the latter one, functions as an image processing circuit for two-dimensional display for driving the Image display device 8. Further, the CGROM 76 functions as storage means, which previously stores the image data for stereoscopic viewing and supplies the video processor 73 and so on with the data. The barrier control section 78 has a role, together with a barrier drive circuit 87 described later, of switching the state of the LCD barrier 83 of the image display device 8 to either one of operation state, non-operation state, and partial operation mode. It should be noted that the program ROM 75 stores permanent information for the operation of the display control device 70, the work RAM 74 is used as a work area for display control based on the instruction of the game control device 50.

The image display device 8 is a display section operating under control of the display control device 70, and performs various display operations relating to proceeding of the game including the varying display game and so on. The image display device 8 includes a lighting device 81, a display panel 82, and an LCD barrier 83. It should be noted here that the lighting device 81 evenly illuminates the display area of the display panel 82 from behind, the display panel 82 is capable of forming a desired color image by modulating the illuminated light, and the LCD barrier 83 is a mask capable of masking the display panel 82 with a fine cyclic pattern and of making the images formed on the display panel 82 as stereoscopic viewing images of four-viewpoints or two-viewpoints in cooperation with the display panel 82. Among these elements, the lighting device 81 is driven by a backlight drive device 85 under control of the CPU 71 provided to the display control device 70, and emits the illumination light with necessary intensity. The liquid crystal panel 82 is driven by an LCD drive device 86 under control of the video processor 73 of the display control device 70, and forms a color transfer image by modifying the illuminated light. The LCD barrier 83 is driven by the a barrier drive device 87 as a drive circuit under control of the video processor 73 and the barrier control section 78 of the display control device 70, and performs on/off operations, thereby switching between the two-dimensional display (i.e., the plane image display), the whole three-dimensional display (i.e., the whole stereoscopic display), and the partial three-dimensional display (i.e., the local stereoscopic display). It should be noted that in the case in which the LCD barrier 83 becomes the on state, a compositive image for stereoscopic viewing is formed on the display panel 82 for realizing the stereoscopic viewing through the LCD barrier 83. It should be noted here that in the case in which the LCD barrier 83 becomes the on state in whole, namely it becomes the whole operation state, the compositive image for stereoscopic viewing is formed on the display panel 82 all over the area thereof for realizing the stereoscopic viewing all over the area thereof through the LCD barrier 83 in the on state in whole. Further, in the case in which the LCD barrier 83 becomes the partial on state, namely it becomes the partial operation state, the compositive image for stereoscopic viewing is formed locally on the display panel 82 for realizing the stereoscopic viewing in a partial area through the LCD barrier 83 in the partial on state

In the above cases, the image display device 8 and the display control device 70 configure a display device capable of performing stereoscopic display of moving images relating to the proceeding of the game.

Hereinafter, a typical operation of the game machine 2 shown in FIGS. 1 and 2 will be explained. In the game machine 2, the game is started in response to a game ball struck out towards the game area by a ball launcher (not shown), and the game ball thus struck out descends the game area.

If the game ball enters the start-up hole 9 to win a prize, the game control device 50 performs a lottery, and a command for designating the display content is output to the display control device 70. The image display device 8, which operates under control of the display control device 70, displays a predetermined image in response to the command. If the result of the lottery described above is the bell ringer, in the image display area IA, the display stops in the condition (the bell ringer designs) in which the three designs displayed thereon are the same.

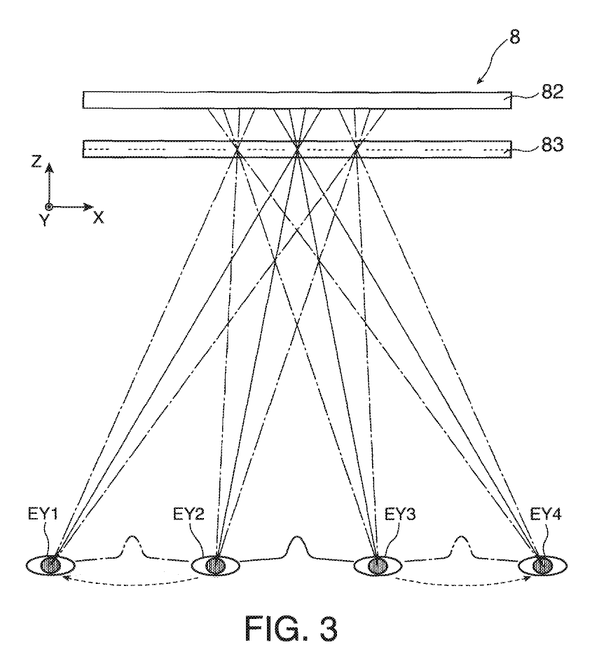

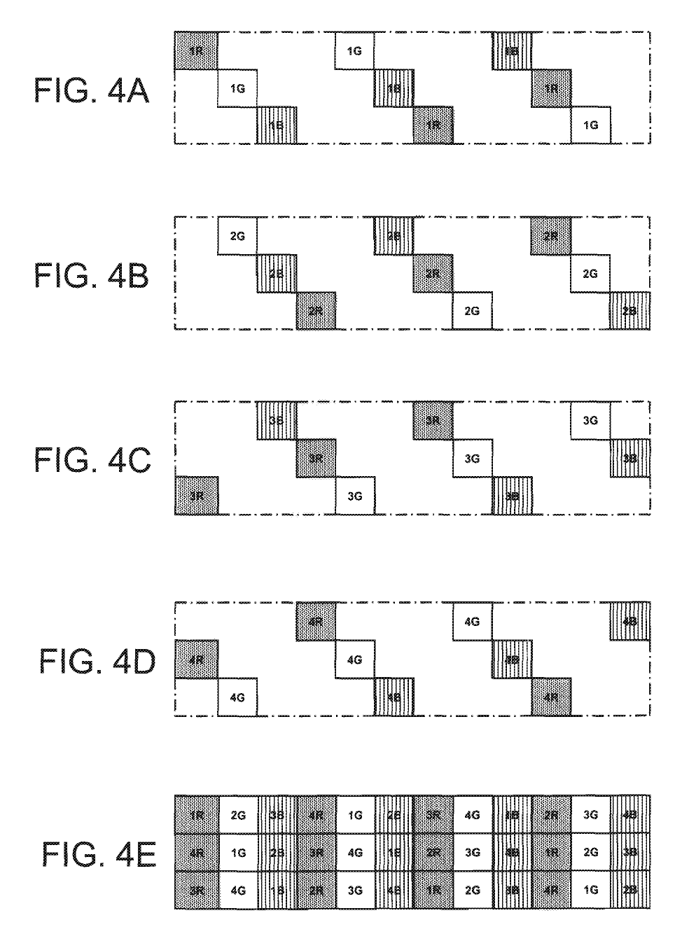

Hereinafter the detail of the image display device 8 will be explained. The image display device 8 allows the stereoscopic viewing in the whole area or the stereoscopic viewing in a partial area by the operation of the LCD barrier 83 as described above. If the LCD barrier 83 is in the off state (in a normal display mode, namely in a plane display mode), no light blocking pattern is formed on the LCD barrier 83 not to cause the light blocking operation in accordance with the light blocking pattern, thus all of the pixels arranged in a plane can be seen. On the contrary, if the LCD barrier 83 is in the on state in whole or in the partial on state, the light blocking with spatial distribution is preformed by the light blocking pattern formed on the LCD barrier 83, thus it becomes impossible to see all of the pixels. Specifically, when moving through the positions of the viewpoints of EY1 through EY4 as shown in FIG. 3, only the pixels corresponding to each of the viewpoints of EY1 through EY4 as enlargedly shown in FIGS. 4A through 4D for example. By using this effect, it is possible to show different images to the left eye and the right eye of the player, thus realizing the stereoscopic viewing.

It should be noted that FIGS. 4A through 4E explanatory shows an example of a layout of the display pixels forming the display panel 82. FIGS. 4A, 4B, 4C and 4D show an example of arrangement of display pixels kR, kG, and kB (k denotes the viewpoint number) corresponding to the first eye EY1, the second eye EY2, the third eye EY3, and the fourth eye EY4, respectively, shown in FIG. 3. By composing the first through the fourth images as explained with reference to FIGS. 4A through 4D in a lump, the stereoscopic viewing image (the composite image) can be composed (see FIG. 4E). Such a stereoscopic viewing image corresponds to an image of one frame or a part of the image displayed on the image display device 8.

If the target stereoscopic viewing image corresponds to a whole image of one frame, the data (a group of two-dimensional display data as shown in FIG. 4E) of the stereoscopic viewing image of the one whole frame is output from the video processor 73 to the display panel 82 via the LCD drive device 86. Thus the player is allowed to observe the composite stereoscopic viewing image corresponding to the stereoscopic viewing image data input to the LCD drive device 86 through the LCD barrier 83 in the on state in whole, thus recognizing the stereoscopic image on or around the display panel 82. Further, if the target stereoscopic viewing image corresponds to a partial image of one frame, the data (a group of two-dimensional display data as shown in FIG. 4E) of the stereoscopic viewing image of that part of the one frame is output from the video processor 73 to the display panel 82 via the LCD drive device 86. In this case, in the other part than that part, ordinary data for plane viewing image is output from the video processor 73 to the display panel 82 via the LCD drive device 86. Thus, the player is allowed to recognize the stereoscopic image only in the partial area of the display panel 82.

It should be noted that by storing the stereoscopic viewing image (the composite image) composed of a plurality of sequentially varying frames in the CAROM 76 provided to the display control device 70 shown in FIG. 2 for every frame, it can also be possible to display a stereoscopic moving image in the whole area of the display panel 82. If the target stereoscopic viewing image corresponds to a partial image in the one frame, by storing data (a group of two-dimensional display data as shown in FIG. 4E) of the sequentially varying partial image as the series of the stereoscopic viewing images in the CGROM 76, it can also be possible to display a stereoscopic moving image in a partial area of the display panel 82. In these cases, the CGROM 76 only stores two-dimensional images as a frame of images or the partial images, and the image data to be output to the LCD drive device 86 can be created by simply reading out the two-dimensional images or by superposing the two-dimensional images. Namely, in the present display control device 70, the three-dimensional data processing using a polygon or the like can be eliminated, and even if the processing rate of the video processor 73 is relatively low, the moving image display can be performed with sufficient resolution and frame rate.

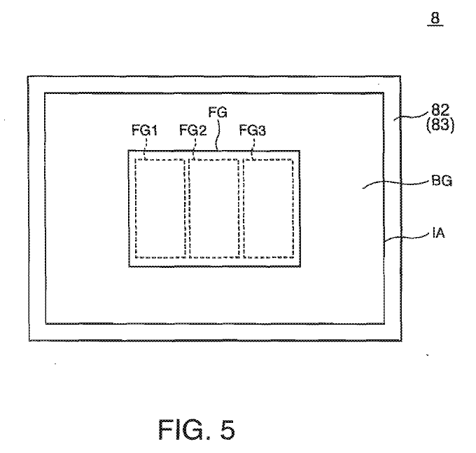

FIG. 5 shows a display example of a stereoscopic image by the image display device 8. In this case, in the image display area IA of the image display device 8, a foreground image FG with undulation in the center section thereof is displayed, and a flat background image BG is displayed in the periphery of the image display area IA of the image display device 8.

The foreground image FG is a varying display area in the varying display game named “reach” which is a part of the game. Namely, three digits of designs assigned as identification information are respectively displayed in the varying display areas FG1 through FG3 provided to the left, the center, and the right of the foreground image FG. In this case, the foreground image FG is for making the display of the stereoscopic figure possible, and is stored in the CGROM 76 provided to the display control device 70 shown in FIG. 2 as a partial image. The foreground image FG is composed of a time series of stereoscopic viewing image data, and the each stereoscopic viewing image data corresponds to the composite image of the four viewpoints exemplifying in FIG. 4E, and realizes the stereoscopic viewing with four viewpoints by itself. Namely, by controlling the timing of reading out the series of stereoscopic viewing image data forming the foreground image FG from the CGROM 76 and making the video processor 73 output the data, it becomes possible to dynamically display a desired stereoscopic image with desired timing. Such stereoscopic viewing image data is calculated by, for example, performing three-dimensional image processing with an external high-speed computer. Specifically, regarding the images of the object approximated by, for example, the polygon or the texture mapping, the images corresponding to the observation from four viewpoints corresponding to the viewpoints EY1 through EY4 shown in FIG. 3 are individually rendered (image processing). In this case, processes necessary for performances or effects are collaterally preformed. Further, by repeating the above operation while moving or modifying the polygon or the like, images varying in time series are calculated as a moving image for every viewpoint.

On the other hand, the background image BG is typically a static or simple image, and can be an image including a character or the like. In this case, it is assumed that the background image BG is a two-dimensional image, and the image data for forming a two-dimensional image by being observed through the LCD barrier 83 in the off state is prepared. As such image data for two-dimensional display, the result of the operation conducted by an external computer can be stored in the CGROM 76 provided to the display control device 70 shown in FIG. 2 as the two-dimensional image data. It should be noted that the background image BG is not limited to a static image but can be a moving image, and in this case, the image data for every frame forming the moving image is stored, for example, in the CGROM 76.

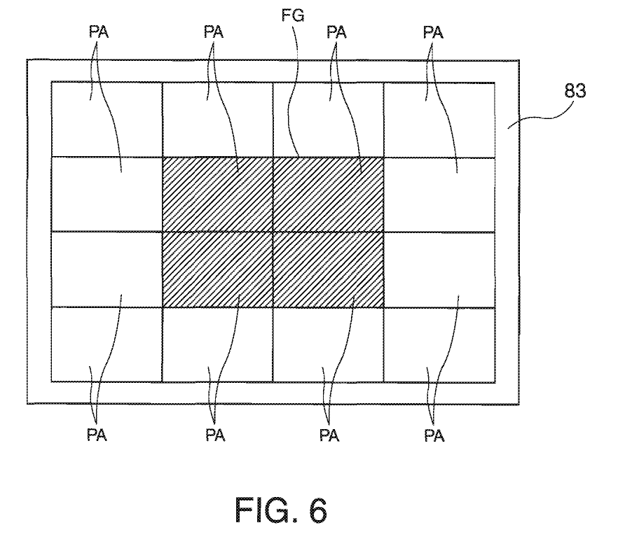

FIG. 6 is a diagram for explaining the role of the LCD barrier 83 provided to the image display device 8. In this case, the LCD barrier 83 is composed of a four-by-four matrix, namely sixteen blocks of partial areas PA. Each of the partial areas PA is configured to be switched on and off independently, and any of partial areas selected as desired can be displayed with stereoscopic images. In the example shown in the drawing, the two-by-two blocks of partial areas PA in the center illustrated with hatching are partially switched on, and the stereoscopic viewing is possible in these four blocks of partial areas PA. If the four partial areas PA corresponding to the center area of the foreground image FG are switched on as shown in the drawing, the composite image (see FIG. 4E) for stereoscopic viewing is formed only in the portion (partial image display area) existing behind the four partial areas PA in the image display area of the display panel 82. As a result, the stereoscopic viewing can be realized in the center area of the LCD barrier 83 which has become the on state. On the other hand, other twelve blocks of the partial areas PA are in the off state, the plane viewing becomes possible in these twelve blocks of the partial areas PA surrounding the four areas in the center thereof.

It should be noted that the partial areas PA shown in FIG. 6 are exemplifications only, and it is possible to divide the LCD barrier 83 into a matrix arrangement of n-by-m (n and m are given positive integers) to define the partial areas. Further, the arrangement of the partial areas are not limited to the matrix arrangement, but the LCD barrier 83 can be divided in to one or more of areas of any shapes (e.g., polygon, ellipse, doughnut-shape, an outline of a character or other displayed materials) and the remaining. Further, it is not necessary to switch on and off every partial areas, but some partial areas can be fixed to the on state, or some of the partial areas can be fixed to the off state.

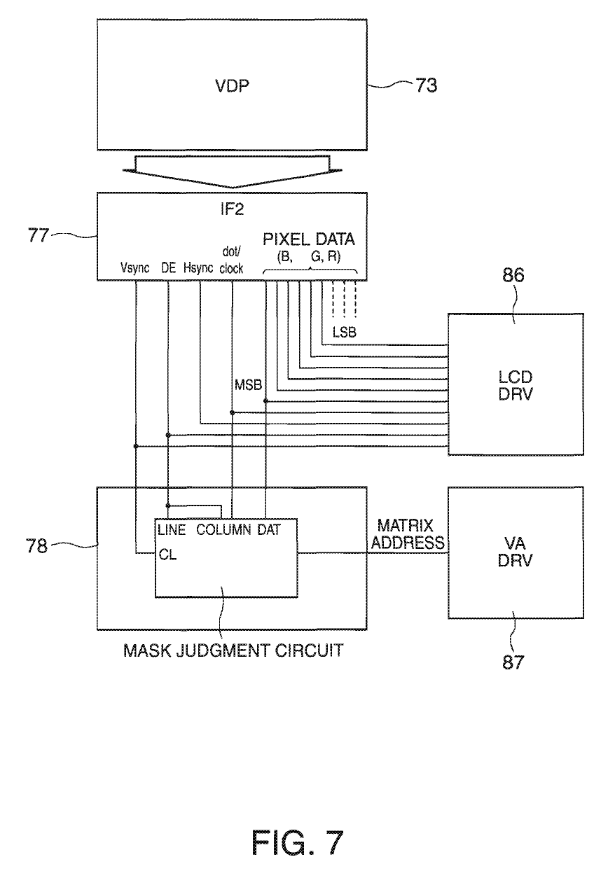

FIG. 7 is a diagram for explaining the roles of output interfaces 77 and a barrier control section 78 provided to the image display device 70. The output interface 77 changes the image data output from the video processor 73, namely a group of two-dimensional display data to those suitable for driving the display panel 82. The barrier control section 78 branches the outputs of the output interface 77 and appropriately processes them to separate and extract barrier control information suitable for driving the barrier drive device 87.

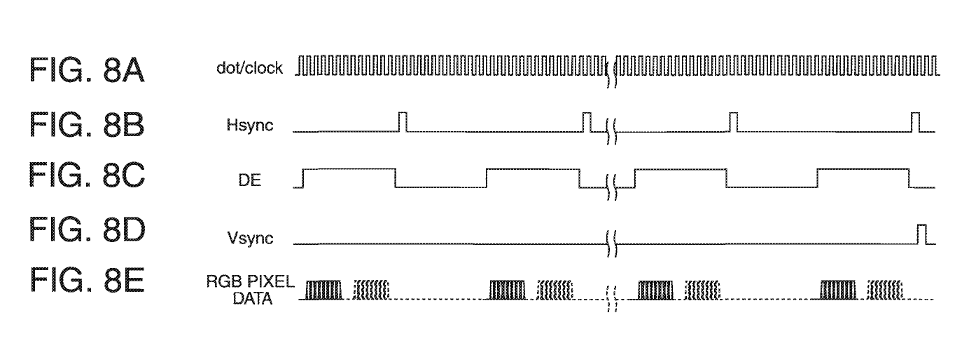

The output interface 77 is provided with dot/clock terminal, Hsync terminal, DE terminal, Vsync terminal, and pixel data terminals. It should be noted here that the dot/clock terminal outputs a waveform as exemplified in FIG. 8A, and the rising of the output of the terminal to the H state defines the output timing of the pixel data corresponding to each pixel composing the display panel 82. Further, the Hsync terminal outputs a waveform as exemplified in FIG. 8B, and the rising of the output of the terminal to the H state represents the completion of the output of the pixel data corresponding to the horizontal scan line composing the display panel 82. Further, the DE terminal outputs a waveform as exemplified in FIG. 8C, and is kept in the on state during the data of the pixel corresponding to the horizontal scan line composing the display panel 82 is continued to be output. Further, the Vsync terminal outputs a waveform as exemplified in FIG. 8D, and the H state of the output of the terminal represents the completion of the sub-scan operation in the vertical direction for composing the display panel 82, namely the completion of output of the all pixel data. Further, the pixel data terminals are provided for every color, namely red (R), green (G), and blue (B), and the parallel data composed of six pins for every color, totally eighteen bits is output (in the drawing, the outputs for blue are only exemplified with solid lines as an example).

The barrier control section 78 is a section for branching a part of the pixel data to be output by the output interface 77 to the LCD drive device 86 to create a control signal output to the barrier drive device 87. The barrier control section 78 corresponds to a barrier control means according to the invention, and configures the barrier device according to the invention together with the barrier drive device 87 and the LCD barrier 83. Although there are various configurations of the barrier drive device 87, the case in which the mask judgment circuit is embedded will be explained here. In this case, the barrier control section 78, namely the mask judgment circuit creates the barrier control information regarding which of the number of the partial areas PA as exemplified in FIG. 6 should be switched to the on state as a matrix address signal, and outputs it to the barrier drive device 87. Namely, the matrix address signal designates the partial areas PA forming the LCD barrier 83, and is held in the H state during the time period in which the partial areas are held in the on state. Although various circuit configurations can be used as the mask judgment circuit, for example, It is assumed that the most significant bit (MSB) of the blue pixel data terminals can also be taken out as the signal for inputting to the barrier control means. In this case, the column position in the horizontal direction can be specified by counting the output of the dot/clock terminal while watching the DE terminal, and the line position in the vertical direction can be specified by counting the output of the DE terminal while watching the toggle on the Vsync terminal. Thus, it becomes possible to specify which pixel the MSB obtained as the signal comes from, and if the MSB is in condition for setting the on state of the LCD barrier 83 corresponding to one pixel (it can be switched to the on state if it has not already been set to the on state), the matrix address signal relating to the partial area PA is set to the on state. On the other hand, if the MSB is in the off state, and in the condition for setting the off state of the LCD barrier 83 in the corresponding pixel, the matrix address signal relating to the partial area PA is set to the off state. It should be noted that the mask judgment process and the variation in the matrix address signal accompanied therewith are continuously performed on the each of the drawing frames triggered by the toggle on the Vsync terminal.

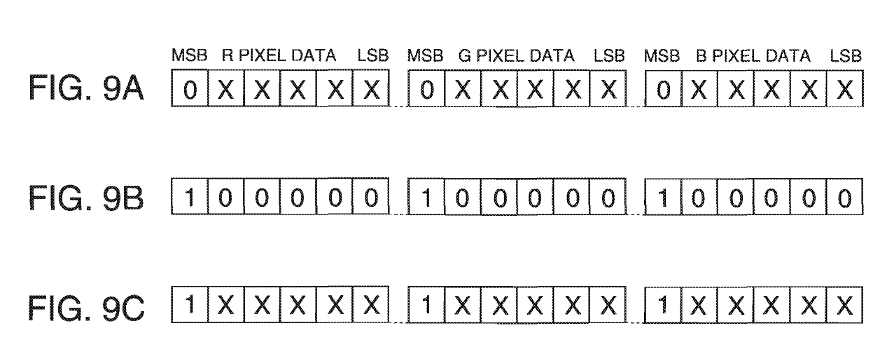

FIGS. 9A through 9C are diagrams for explaining creation of image data output from the output interface 77. FIG. 9A shows the pixel data for performance display, which is previously stored in the CGROM 76 and processed by the video processor 73, FIG. 9B shows the pixel data for blending, which is previously stored in the CGRON 76 and processed by the video processor 73, and FIG. 9C shows the pixel data to be output from the video processor 73. The pixel data shown in FIG. 9A corresponds to the three primary colors of red, green, and blue with the MSB values of “0.” Namely, the pixel data shown in FIG. 9A is arranged to be able to display the image with the brightness compressed to the low brightness side. The pixel data shown in FIG. 9B corresponds to the three primary colors of red, green, and blue with the MSB values of “1” and values of other bits of all “0.” Namely, the pixel data shown in FIG. 9B is arranged to be able to display the light gray image. Further, the pixel data shown in FIG. 9C is obtained by “additional blending” the pixel data shown in FIG. 9A and the pixel data shown in FIG. 9B. Namely, the pixel data shown in FIG. 9C is for increasing the brightness of the image for performance display as much as the amount corresponding to the light gray, namely the pixel data shown in FIG. 9C realizes the display similar to the high-lighting. It should be noted that the “additional blending” of the pixel data shown in FIGS. 9A and 9B is realized easily and quickly as a function of the video processor 73. By the “additional blending,” a light gray sprite (see FIG. 9B for the pixel data thereof) corresponding to the shape of the area (specifically, see, for example, the foreground image FG shown in FIG. 5) on which the stereoscopic viewing is required is previously prepared in the CGROM 76 or is calculated by the video processor 73, and the sprite can be composed with the image (see FIG. 9A for the pixel data thereof) for performance display and displayed. Although the light gray additional blending as described above is for forcedly modifying the image for performance display brighter, since in the partial areas PA (see FIG. 6) where the LCD barrier 83 is switched on, the brightness is apt to decrease due to the influence of the stereoscopic viewing; namely the influence of the existence of the light blocking pattern, there is caused a secondary advantage of canceling such drop of the brightness with the light gray additional blending. Namely, by performing the light gray additional blending, it becomes difficult for the player to actually sense the variation in the brightness if the image display device 8 is switched from the ordinary display with plane viewing to the stereoscopic display with stereoscopic viewing.

It should be noted that the pixel data shown in FIGS. 9A and 9C are the pixel data output from the output interface 77 to the LCD drive device 86 and partially includes the barrier control information to be separated by the barrier control section 78 shown in FIG. 7. Namely, in the barrier control section 785 it is sufficient to Judge whether the value of the MSB of the pixel data of either one of the colors in the pixel data exemplified in FIGS. 9A and 9C is set to “0” or “1,” and it is conceivable that each of the pixel data includes the information relating to whether or not the LCD barrier 83 should be set to the on state in the present pixel position. It should be noted that in the present embodiment, since the LCD barrier 83 is not set to the on state for every pixel, the advantage is obtained by switching on the operation of the partial areas PA covering such pixels. Since the specific process has already explained in detail as the function of the barrier control section 78 shown in FIG. 7, the explanations therefor will be omitted here. It should be noted that, although it is also possible in principle to set the partial area of the LCD barrier 83 to the on state for every pixel, it is more practicable to switch the partial area of the LDC barrier 83 to the on or off state for every group of pixels.

By performing aforementioned process, the load of the video processor 73 required for the on/off control of the stereoscopic viewing can dramatically be reduced, and in particular, in the video processor 73 in the present embodiment, which is the drawing system for performing the two-dimensional image processing by appropriately retrieving the two-dimensional display data stored in the CGROM 76, a large effect of load reduction can be exerted.

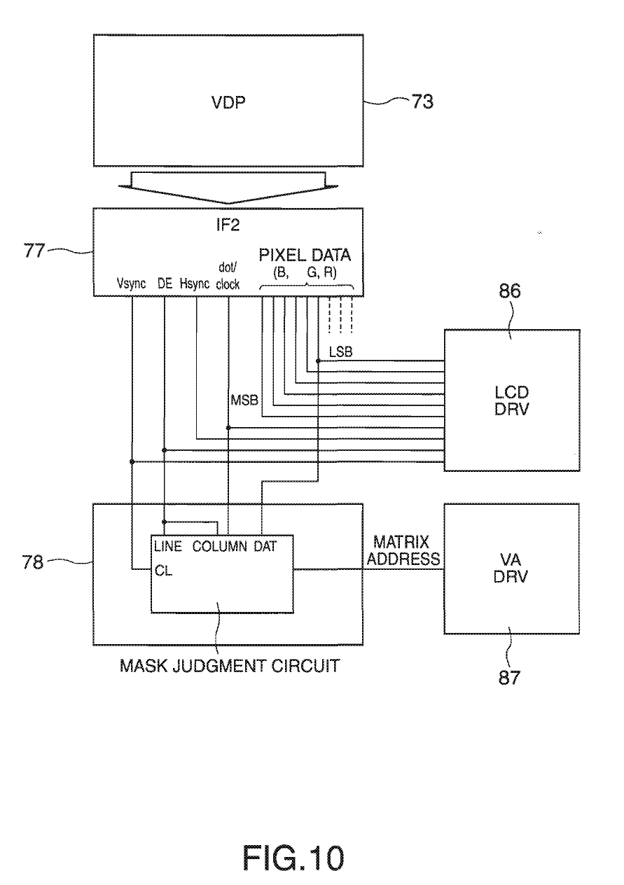

FIG. 10 is a diagram for explaining a modification of the barrier control section 78 and so on shown in FIG. 7. Also in this case, the barrier control section 78 is a section for branching a part of the pixel data to be output by the output interface 77 to the LC drive device 86 to create a control signal output to the barrier drive device 87. In this case, the mask judgment circuit configuring the barrier control section 78 creates the barrier control information regarding which of the number of the partial areas PA as exemplified in FIG. 6 should be switched to the on state as a matrix address signal, and outputs it to the barrier drive device 87. In this case, the mask judgment circuit can be arranged to take out the least significant bit (LSB) of the blue pixel data terminals, for example. In this case, the column position and the line position can be specified by the dot/clock terminal and the DE terminal, which pixel the LSB obtained as the signal comes from can be specified, and if the LSB is the on state and is in condition for setting the LCD barrier 83 to the on state in the corresponding pixel, the matrix address signal related to the partial area PA is set to the on state. On the other hand, if the LSB is in the off state, and in the condition for setting the off state of the LCD barrier 83 in the corresponding pixel, the matrix address signal relating to the partial area PA is set to the off state.

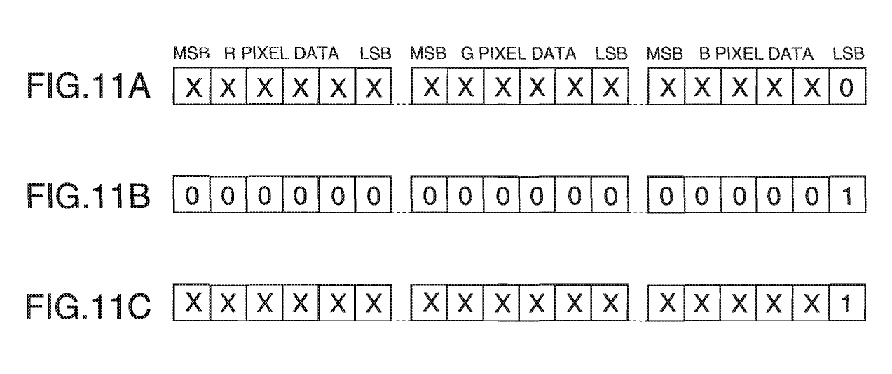

FIGS. 11A through 11C are diagrams for explaining creation of image data output from the output interface 77. FIG. 11A shows the pixel data for performance display, which is previously stored in the CGROM 76 or processed by the video processor 73, FIG. 11B shows the pixel data for blending, which is previously stored in the CGROM 76 or processed by the video processor 73, and FIG. 11C shows the pixel data to be output from the video processor 73. The pixel data shown in FIG. 11A corresponds to the three primary colors of red, green, and blue in which the LSB value only in the blue pixel data is set to “0.” Namely, the pixel data shown in FIG. 11A corresponds to an image with the lowered blue gray scale. Further, the pixel data shown in FIG. 11B has the LSB value of “1” and values of other bits of all “0” in the blue pixel data. Namely, the pixel data shown in FIG. 11B corresponds to an image with the darkest blue color. Further, the pixel data shown in FIG. 1C is obtained by “additional blending” the pixel data shown in FIG. 11A and the pixel data shown in FIG. 11B. By the “additional blending,” a dark blue sprite (see FIG. 11B for the pixel data thereof) corresponding to the shape of the area (specifically, see, for example, the foreground image FG shown in FIG. 5) on which the stereoscopic viewing is required can be composed with the image (see FIG. 11A for the pixel data thereof) for performance display, and displayed. Although the additional blending as described above is for emphasizing the blue gray scale of the image for performance display for one step, since the luminosity factor of blue is originally low, no visual problem arises and no uncomfortable feeling is caused to the player.

It should be noted that the pixel data shown in FIGS. 11A and 11C are the pixel data output from the output interface 77 to the LCD drive device 86 and includes the barrier control information to be separated by the barrier control section 78 shown in FIG. 10. Namely, in the process in the barrier control section 78, it is nudge whether the value of the LSB of the blue pixel data of either of the pixel data exemplified in FIGS. 11A and 11C is set to “0” or “1,” and the blue pixel data includes the information relating to whether or not the LCD barrier 83 should be set to the on state in the present pixel position. It should be noted that in the present embodiment, since the LCD barrier 83 is not set to the on state for every pixel, the advantage is obtained by switching on the operation of the partial areas PA covering such pixels.

In the modified example as described above, although the barrier control information is carried on the LSB of the blue pixel data, the barrier control information can be carried ob the LSB of the red pixel data or the LSB of the green pixel data if there are no objections in display.

In the first embodiment described above, although the pixel data terminals in the output interface 77 shown in FIGS. 7 and 10 are six pins for each color and totally eighteen bits, the specification of the pixel data terminals should appropriately be changed in accordance with the usage. Therefore, these terminals can be replaced with a parallel interface handling data with appropriate number of bits in a range of, for example, a few bits through twenty-odd bits.

Further, in the above first embodiment of the invention, although the pixel position is specified, and the on/off state of the each of partial areas forming the barrier is specified using the outputs of the dot/clock terminal and the DE terminal, the Hsync terminal or other terminals can also be used, and the signal processing method can be changed accordingly.

### Second Embodiment

Hereinafter, a game machine and a display device implemented thereto according to a second embodiment of the invention will be explained with reference to the accompanying drawings. It should be noted that the game machine and so on according to the second embodiment are modifications of the game machine and so on of the first embodiment, and accordingly, portions with no particular explanations are the same as those in the first embodiment, and the same sections are provided with the same reference numerals and any duplicated explanations will be omitted.

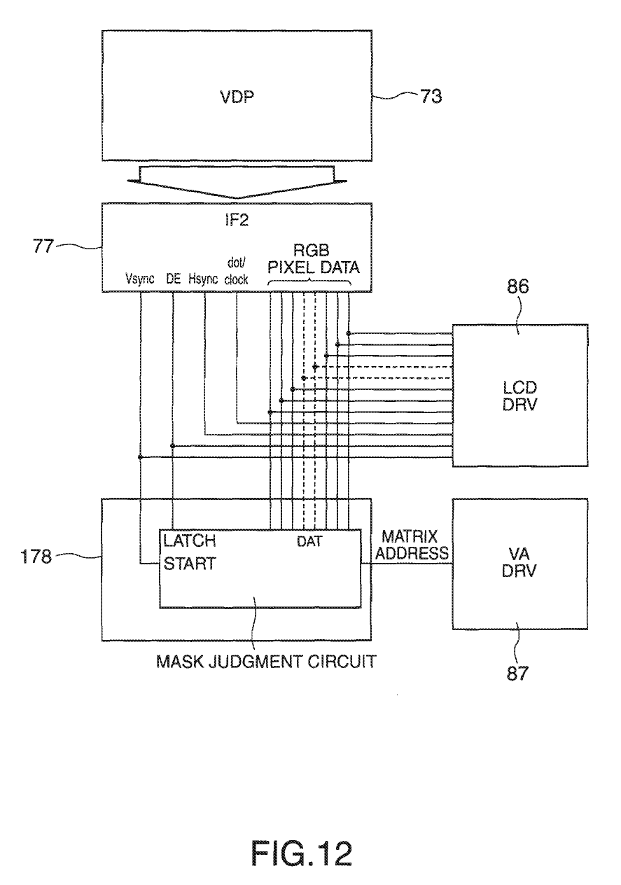

FIG. 12 is a diagram for explaining the relevant section of the display control device 70 implemented in the present embodiment. The barrier control section 178 branches a part of the image data to be output by the output interface 77 to the LCD drive device 86 to create a control signal output to the barrier drive device 87. In this case, the mask judgment circuit configuring the barrier control section 178 creates the barrier control information regarding which of the number of the partial areas PA as exemplified in FIG. 6 should be switched to the on state as a matrix address signal, and outputs it to the barrier drive device 87. The mask judgment circuit is assumed to take out the data from all of the pixel data terminals of all of the colors. In this case, the data reading out is started in response to the toggle on the Vsync terminal, and the data is latched in response to the toggle on the DE terminal. Thus, the eighteen bit of parallel data bundling all of the six bits for each of the three colors can be taken out. It should be noted here that since the timing of latching the data is set by the rising of the signal on the DE terminal, the pixel data for performance display output from the video processor 73 includes meaningless part corresponding to the barrier control information in the one vertical line in the left end of the display panel 82. However, the left end vertical line is usually masked easily by existence of a masking member or the like, and accordingly, it can hardly obstruct the view of the player. It should be noted that if a mask is provided in the display panel 82 side with a filter, or the data removal is performed in the left vertical line with the control by the logic circuit elements, a process equivalent to lighting-off is performed, and accordingly, there is no chance for the control data to be observed by the player.

As described above, the barrier control information embedded in the vertical line in the left end of the display panel 82 is eighteen bits of parallel data, and can be decoded by a decoder circuit (not shown) embedded in the barrier control section 178 as the barrier control protocol signal. Such barrier control protocol information is output to the barrier drive device 87 as the matrix address signal directly or after processed by the barrier control section 178.

Meanwhile, the video processor 73 builds the barrier control information into the image data corresponding to the image to be displayed on the display panel 82 under control of the CPU 71. In this case, the video processor 73 embeds the barrier control information as the line data by sequentially writing the color and brightness data, which correspond to a signal to be decoded as the barrier control protocol, as a dot in one left end vertical line.

In the above process, although the barrier control information is embedded in the section corresponding to the left end vertical line in the image data to be output to the display panel 82, the barrier control information can be embedded in the section corresponding to the right end vertical line in the image data, or the section corresponding to the upper end of the lower end horizontal line in the image data, and the barrier control information can also be sent out to the barrier control section 178 and the barrier drive device 87.

### Third Embodiment

Hereinafter, a game machine and a display device implemented thereto according to a third embodiment of the invention will be explained with reference to the accompanying drawings. It should be noted that the game machine and so on according to the third embodiment are modifications of the game machines and so on according to the second embodiment.

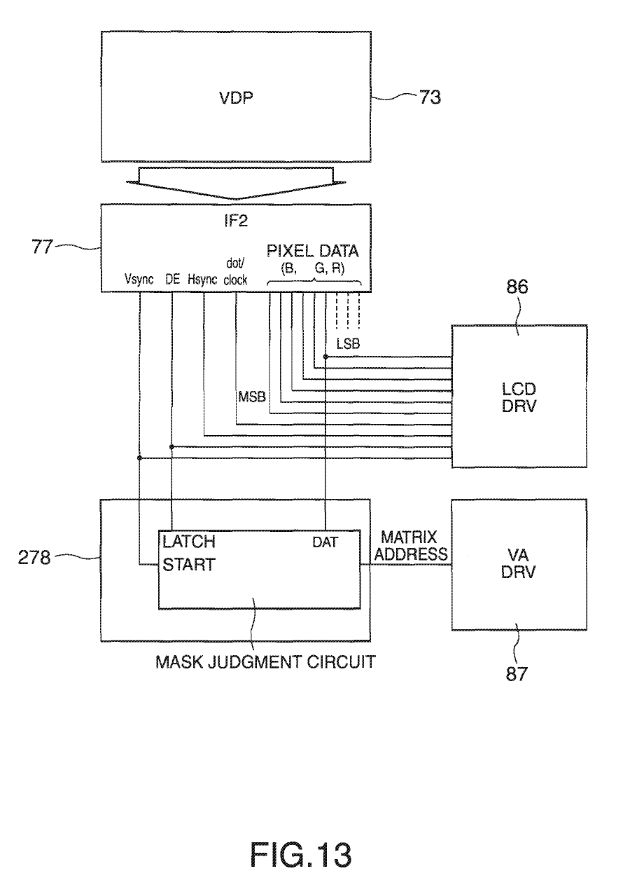

FIG. 13 is a diagram for explaining the relevant section of the display control device 70 implemented in the present embodiment. The barrier control section 278 branches a part of the image data to be output by the output interface 77 to the LCD drive device 86 to create a control signal output to the barrier drive device 87. In this case, the mask judgment circuit configuring the barrier control section 278 creates the barrier control information regarding which of the number of the partial areas PA as exemplified in FIG. 6 should be switched to the on state as a matrix address signal, and outputs it to the barrier drive device 87. The mask judgment circuit is assumed to be able to take out data from only the LSB of the blue pixel data out of the pixel data terminals. In this case, the data reading out is started in response to the toggle on the Vsync terminal, and the data is latched in response to the toggle on the DE terminal. Thus, the one bit of serial data can be taken out using a single pixel data terminal. It should be noted here that since the timing of latching the data is set by the rising of the signal on the DE terminal, the pixel data for the performance display output from the video processor 73 includes meaningless part corresponding to the barrier control information in the least significant bit of the blue pixel data terminals in the left end vertical line of the display panel 82. However, as a result, it is nothing more than emphasizing the image for the performance display in the blue gray scale for one step, therefore, no visual problem arises and no uncomfortable feeling is caused to the player.

As described above, the barrier control information embedded in the vertical line in the left end of the display panel 82 is one bit of serial data, and can be decoded by a decoder circuit knot shown) embedded in the barrier control section 278 as the barrier control protocol signal. Such barrier control protocol information is output to the barrier drive device 87 as the matrix address signal directly or after processed by the barrier control section 278.

Meanwhile, the video processor 73 builds the barrier control information into the image data corresponding to the image to be displayed on the display panel 82 under control of the CPU 71. In this case, the video processor 73 embeds the barrier control information as the line data by sequentially writing the signal to be decoded as the barrier control protocol as the least significant bit of the blue brightness data as a dot in one left end vertical line.

Although in the above embodiment, the barrier control information is carried of the LSB of the blue pixel data in the left end vertical line, as a modified example, it is possible to handle the LSB of the blue pixel data in the upper horizontal line as the serial data. Further, if there are no objections in display, the barrier control information can be carried on the LSB of the red pixel data or the LSB of the green pixel data instead of the blue pixel data.

Further, in the above embodiment, although the barrier control information is embedded in the section corresponding to the left end vertical line in the image data to be output to the display panel 82, the barrier control information can be embedded in the section corresponding to the right end vertical line in the image data, or the section corresponding to the upper end or the lower end horizontal line in the image data, and the barrier control information can also be sent out to the barrier control section 278 and the barrier drive device

### Fourth Embodiment

Hereinafter, a game machine and a display device implemented thereto according to a fourth embodiment of the invention will be explained with reference to the accompanying drawings. It should be noted that the game machine and so on according to the fourth embodiment are modifications of the game machine and so on according to the first embodiment.

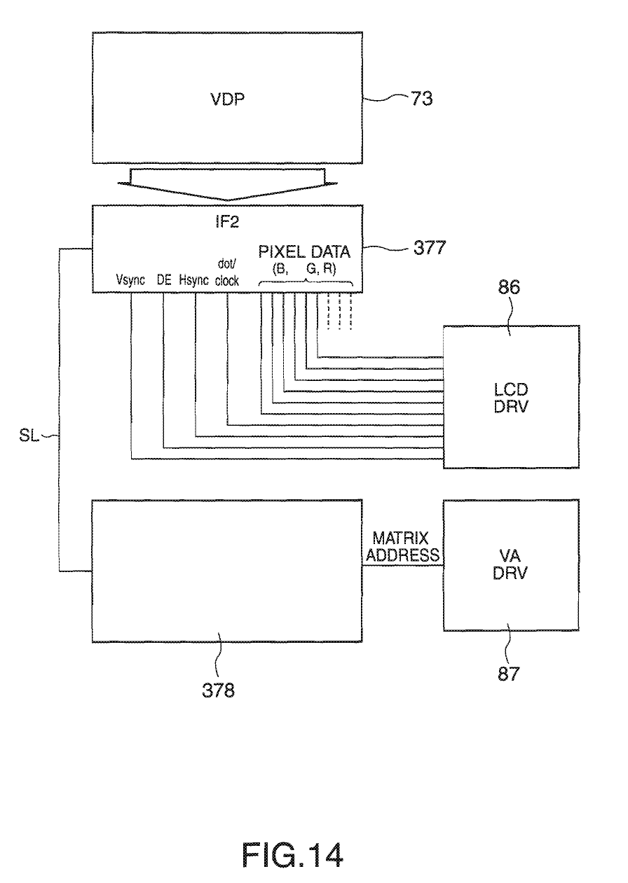

FIG. 14 is a diagram for explaining the relevant section of the display control device 70 implemented in the present embodiment. The output interface 377 is provided with a dedicated signal line, namely the communication cable SL, capable of independently outputting the barrier control signal to the barrier control section 378. The barrier control section 378 receives the barrier control information via the communication cable SL, and the outputs the barrier control information to the barrier drive device 87 as the matrix address signal. Here, the barrier control information communicated through the communication cable SL is a signal of a predetermined barrier control protocol, and includes instruction information regarding which of a number of the partial areas PA exemplified in FIG. 6 should be switched on. It should be noted that the communication cable ST can be the one bit serial transmission system, but can also be the multi-bit parallel transmission system.

In the embodiment described above, since the output interface 377 is for the LCD drive device 86 by nature, it is possible to provide an output interface dedicated to the barrier control signals independently from the output interface 377, and to intervene between the video processor 73 and the barrier control section 378, or the video processor 73 and the barrier drive device 87.

Although the invention is explained along the embodiments described above, the invention is not limited to the above embodiments. For example, although in the embodiments described above, the display panel 82 composed of the liquid crystal display device is built in the image display device 8, a rear projection type of projector, a CTR, or the like can be used instead of the liquid crystal display device. Further, the method of realizing the stereoscopic viewing is not limited to the method using a kind of parallax barrier as in the embodiments, but various stereoscopic viewing methods such as a lenticular lens array (e.g., JP-A-7-16351) or an image splitter (e.g., JP-A-9-164263).

Further, although in the above embodiments, the LCD barrier 83 and the display panel 82 for four viewpoints are used, those for two viewpoints can be used for the stereoscopic viewing by changing the design of the LCD barrier 83.

Further, although in the embodiments described above, the image display device 8 is built in the game machine 2, the image display device 8 and the display control device 70 can be built in other devices (e.g., a vehicle navigation system, and various home electric appliances including a TV game). In this case, the display position of the stereoscopic image can be set to a desired location and a desired area in the display screen by the control of the display control device 70.

The entire disclosure of Japanese Patent Application No. 2005-239402, filed Aug. 22, 2005 is expressly incorporated by reference herein.

What is claimed is:

1. A display device comprising:
a display panel having a planar image display area;
a barrier device having a barrier disposed opposing to the image display area, and switchable between an operative state for allowing stereoscopic viewing and an inoperative state for disabling stereoscopic viewing, wherein in the operative state, the barrier device can locally be set to a partial operative state in which a part of the image display area is covered by the barrier; and
a control device that outputs barrier control information to the barrier device to make the barrier device switch the state of the barrier including the partial operative state.

2. The display device according to claim 1, wherein the barrier device is divided into a plurality of partial areas, and each of the partial areas is set to one of the operative state and the inoperative state in the partial operative state.

3. The display device according to claim 2, wherein the barrier device includes a drive circuit that switches each of the partial areas to one of the operative state and the inoperative state.

4. The display device according to claim 2, wherein the display panel operates in accordance with image data input to the display panel, and the control device includes the barrier control information in the image data, and the barrier device includes a barrier control device that separates the barrier control information from the image data.

5. The display device according to claim 4, wherein the control device performs additional blending of a predetermined digit of a digital brightness signal forming the image data with a predetermined signal including the barrier control information.

6. The display device according to claim 4, wherein the control device replaces at least a part of a left vertical line of a digital brightness signal forming the image data with the barrier control information.

7. The display device according to claim 4, wherein the control device replaces at least a part of a left vertical line relating to a predetermined color of a digital brightness signal forming the image data with the barrier control information.

8. The display device according to claim 1, further comprising
a communication cable for transmitting the barrier control information output from the control device to the barrier device.

9. A game machine comprising:
the display device according to claim 1 that performs stereoscopic viewing in a display section; and
a performance control device that makes the display device perform stereoscopic viewing display in accordance with status of the game.

10. A method of controlling a display device switchable between an operative state for allowing stereoscopic viewing and inoperative state for disabling stereoscopic viewing, comprising:
setting locally, in the operative state, the barrier device to a partial operative state in which a part of the image display area is covered by the barrier.

11. A method of controlling a display device comprising controlling the display device according to claim 1, thereby allowing partial stereoscopic viewing.

12. A method of controlling a game machine, comprising controlling the game machine according to claim 9, thereby allowing partial stereoscopic viewing of the display device.
